(19) United States
(12) Patent Application Publication
(10) Pub. No.: US 2011/0051041 A1
(43) Pub. Date: Mar. 3, 2011

(54) BACKLIGHT UNIT AND LIQUID CRYSTAL DISPLAY DEVICE

(76) Inventor: Yuji Yashiro, Osaka (JP)

(21) Appl. No.: 12/990,917

(22) PCT Filed: Dec. 19, 2008
(86) PCT No.: PCT/JP2008/073183

§ 371 Date: Nov. 3, 2010

(30) Foreign Application Priority Data
May 16, 2008 (JP) 2008-129180

(51) Int. Cl. G02F 1/1335; F21V 7/22

(52) U.S. Cl. 349/62; 362/606

(57) ABSTRACT

The top surface (41U) of a light guiding plate (41) includes two kinds of regions, i.e., a line grid region (LR) and a scattered grid region (SR). The line grid region (LR) is positioned at a part where light which propagates along a Y direction reaches, on the top surface (41U). The scattered grid region (SR) is positioned at a part where light which propagates in directions deviated from the Y direction reaches, on the top surface (41U).

### TECHNICAL FIELD

The present invention relates to a backlight unit and a liquid crystal display device.

### BACKGROUND ART

Usually, a backlight unit that supplies light to a non-light emitting type liquid crystal display panel includes a light guide plate that is formed of a transparent resin to evenly guide light from a light source such as an LED (Light Emitting Diode) or the like to the liquid crystal display panel. And, this light guide plate makes light received by an end surface (e.g., side surface) of itself undergo multiple reflection therein and outputs the light from a top surface (output surface).

Here, to increase the light output efficiency from the light guide plate, conventionally, a prism pattern is formed on a top surface or a bottom surface of the light guide plate and light refracted by the prism goes out of the top surface. Or, a pattern of scattering dots is formed on the top surface or the bottom surface of the light guide plate and light diffused by the dots goes out of the top surface.

However, the prism in the light guide plate is relatively large, so that in a case where the liquid crystal display device is visually observed, the prism is likely to be conspicuous. In addition, the thickness of the light guide plate is likely to become thick because of the prism and also the thickness of the backlight unit increases. Besides, it is hard to form a desired prism pattern on a surface of the light guide plate, so that a light loss is likely to occur because of a prism pattern that is not a desired pattern. In addition, according to such a prism pattern, it is hard to control the output light from the light guide plate into a desired direction.

Besides, the scattering dot dramatically lowers the percentage of light that is effectively used and it is hard to control the output light from the light guide plate into the desired direction.

As an idea to control the output light from the light guide plate into the desired direction, there is an idea to cover the top surface of the light guide plate with an optical sheet such as a prism sheet or the like. However, because of the presence of the optical sheet, the thickness of the backlight unit increases and further the number of components of the backlight unit also increases (and the cost of the backlight unit increases).

Accordingly, recently, an aggregate of grating lines that are densely disposed on the bottom surface of the light guide plate, that is, a diffraction grating is formed on the light guide plate (incidentally, in many cases, the periodic interval of such a diffraction grating is set at 0.5 to 2 μm for visible light). Because if such a diffraction grating (e.g., a phase-difference type diffraction grating) is included in the light guide plate, light that propagates into the inside of the light guide plate from a side surface of the light guide plate is diffracted and reaches the liquid crystal display panel via the top surface in a large quantity.

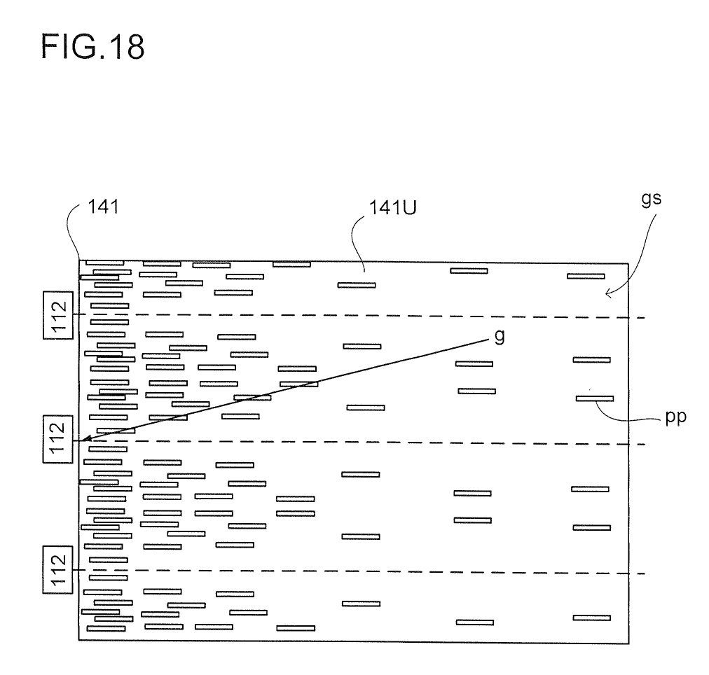

As an example of the light guide plate that includes a diffraction gating, there is a patent document 1. In a backlight unit described in the patent document 1, as shown in a plan view of FIG. 18, grating pieces pp are radially arranged with respect to an LED 112 on a top surface 141U of a light guide plate 141, so that a diffraction grating gs is completed. Especially, in this diffraction grating gs, the grating pieces pp are arranged in lines, so that a diffraction vector (grating vector) g occurs and light along the diffraction vector g is efficiently diffracted.

Patent document 1: JP-A-2006-228595

### DISCLOSURE OF THE INVENTION

### Problems to be Solved by the Invention

Usually, the diffraction grating gs diffracts, at a relatively high diffraction efficiency, light that propagates along the diffraction vector g but diffracts, at only a relatively low diffraction efficiency, light that deviates from the diffraction vector g and propagates. In the diffraction grating gs of the light guide plate 141 described in the patent document 1, the grating pieces pp are indeed arranged radially but arranged linearly to generate the diffraction vector g, so that it is hard to generate a large number of diffraction vectors g on the light guide plate 141. Accordingly, the diffraction grating gs of this light guide plate 141 cannot sufficiently diffract light that propagates in various directions.

The present invention has been made in light of the above situation. And, it is an object of the present invention to provide: a backlight unit that efficiently diffracts light that propagates in various directions in a light guide plate and outputs the light to outside; and to provide a liquid crystal display device that includes the backlight unit.

### Means for Solving the Problem

The backlight unit has a light source; and a light guide plate that receives light from the light source, makes the light undergo multiple reflection and outputs the light to outside. Here, in the light guide plate, a surface that receives the light is a light reception surface, a surface disposed opposite to the light reception surface is an opposite surface, a surface that outputs the light to outside is an output surface, and a shortest direction from the light reception surface to the opposite surface is a first direction.

According to this, a diffraction grating is formed on the output surface; in the diffraction grating, a first region that makes a diffraction vector having a same direction as the first direction occur and a second region that makes a diffraction vector having a direction different from the first direction occur are included. And, the first region is situated at an arrival portion of the output surface where light that propagates along the first direction reaches; and the second region is situated at an arrival portion of the output portion where light that deviates from the first direction and propagates reaches.

According to this, because light that propagates along the first direction is diffracted by the diffraction grating of the first region that has the diffraction vector which has the same direction as the first direction, the light is diffracted at a relatively high diffraction efficiency. Besides, because light that deviates from the first direction and propagates is diffracted by the diffraction grating of the second region that has the diffraction vector which has a direction different from the first direction, the possibility that the propagation direction of the light and the direction of the diffraction vector match each other increases and the diffraction efficiency becomes high.

In other words, the light guide plate includes a plurality of kinds of diffraction gratings (the diffraction grating of the first region and the diffraction grating of the second region) in accordance with the propagation directions of the light and is able to diffract the light in accordance with the propagation directions. Because of this, in the entire light guide plate, the possibility that the propagation directions of the light and the directions of the diffraction vectors match each other increases and the diffraction efficiency becomes high. Besides, if the propagation direction of the light and the direction of the diffraction vector matches each other, it becomes easy to design the diffraction grating; and in accordance with the design, for example, it is possible to increase the amount of light that perpendicularly comes out of the output surface of the light guide plate.

Besides, it is desirable that the first region is, on the output surface, situated, along the first direction, from a place that faces a light emitting end of the light source; and the second region is, on the output surface, situated in a place other than the first region.

According to this, because an optical-axis direction of the light source matches the first direction and the amount of light that propagates along the first direction increases, the possibility that the propagation direction of the light and the direction of the diffraction vector matches each other increases and the diffraction efficiency by the diffraction grating of the first region becomes high. Besides, because the light that deviates from the optical axis of the light source reaches the second region, the possibility that the propagation direction of the light and the direction of the diffraction vector different from the first direction matches each other increases and the diffraction efficiency by the diffraction grating of the second region becomes high.

Besides, in a case where characteristics such as incident-angle dependency and the like of the diffraction efficiency must change to increase the output efficiency of light from the light guide plate, the following is desirable

For example, it is desirable that the diffraction grating in the second region has a polygonal-shape grating pattern. Here, the grating pattern may be a quadrangular-shape grating pattern or a hexagonal-shape grating pattern. Besides, it is desirable that a grating piece that constitutes the diffraction grating is a post body. Here, the post body may be a rectangular parallelepiped or a circular cylinder.

Here, it is desirable that the diffraction grating in the second region includes two or more kinds of periodic intervals in a second direction that is a direction which intersects the first direction.

According to this, because there are a plurality of periodic intervals of the diffraction grating in the second direction, many kinds of diffraction vectors occur in accordance with the various periodic intervals and the periodic interval (e.g., a constant periodic interval) of the diffraction grating in the first direction. And, because the diffraction vectors correspond to many kinds of light propagations, it becomes easy for light to perpendicularly come out of the output surface of the second region.

Here, as examples of the diffraction grating in the second region having the two or more periodic intervals in the second direction, there are the following examples.

First, on the output surface, the angle formed between the optical-axis direction of the light source that matches the first direction and the light from the light source is defined as a divergence angle; the second region is divided into regions in an angle range of the divergence angle; and the divided regions are defined as angle division regions. And, in the diffraction grating in the second region that is an example, in the diffraction grating in every one of the angle division regions, the smaller a lower limit value of the angle range is, the longer the periodic interval in the second direction that is the direction which intersects the first direction is.

Besides, as another example, there is the following. First, the optical-axis direction of the light source matches the first direction; a division line that has the same direction as the first direction is arranged on the second region along the second direction that is the direction which intersects the first direction, so that at least a portion of the second region is divided into regions; and the divided regions are defined as parallel division regions. And, in the diffraction grating in the second region that is another example, in the diffraction grating in every one of the parallel division regions, the shorter a shortest distance between the optical-axis direction of the light source closest to the parallel division region and the parallel division region is, the longer the periodic interval in the second direction is.

Here, in the above backlight unit, it is desirable that a bottom surface of the light guide plate that is a surface disposed to be opposite to the output surface is covered by a reflection sheet that guides light leaking from the bottom surface into the light guide plate.

According to this, even if the diffraction grating on the output surface reflects light and the reflected light (diffracted reflected light) is not totally reflected by the bottom surface of the light guide plate and passes through, the light is returned by the reflection sheet back to the light guide plate and goes to the output surface. Accordingly, the amount of output light from the light guide plate increases.

Here, it is possible to say that a liquid crystal display device including: the above backlight unit; and a liquid crystal display panel that receives light from the backlight unit is also the present invention.

### ADVANTAGES OF THE INVENTION

According to the present invention, because a diffraction grating in an output surface of a light guide plate corresponds to a propagation direction of light, the diffraction efficiency increases; moreover the design of the diffraction grating becomes easy. Because of this, in this diffraction grating, for example, the amount of light that perpendicularly comes out of the output surface of the light guide plate increases.

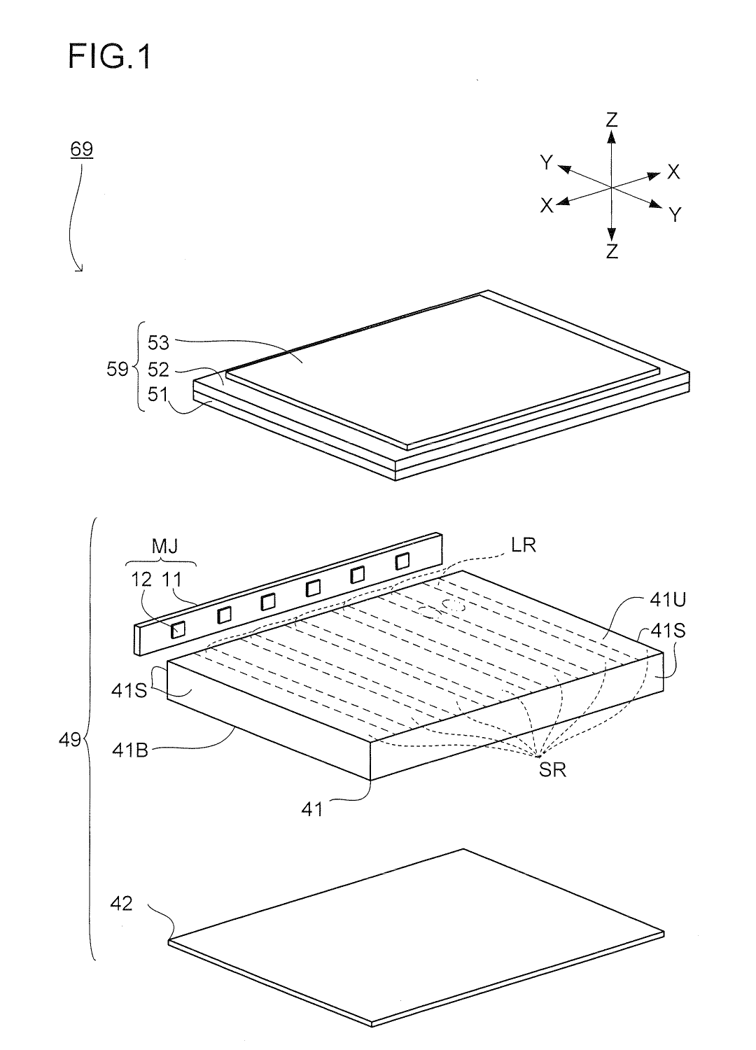

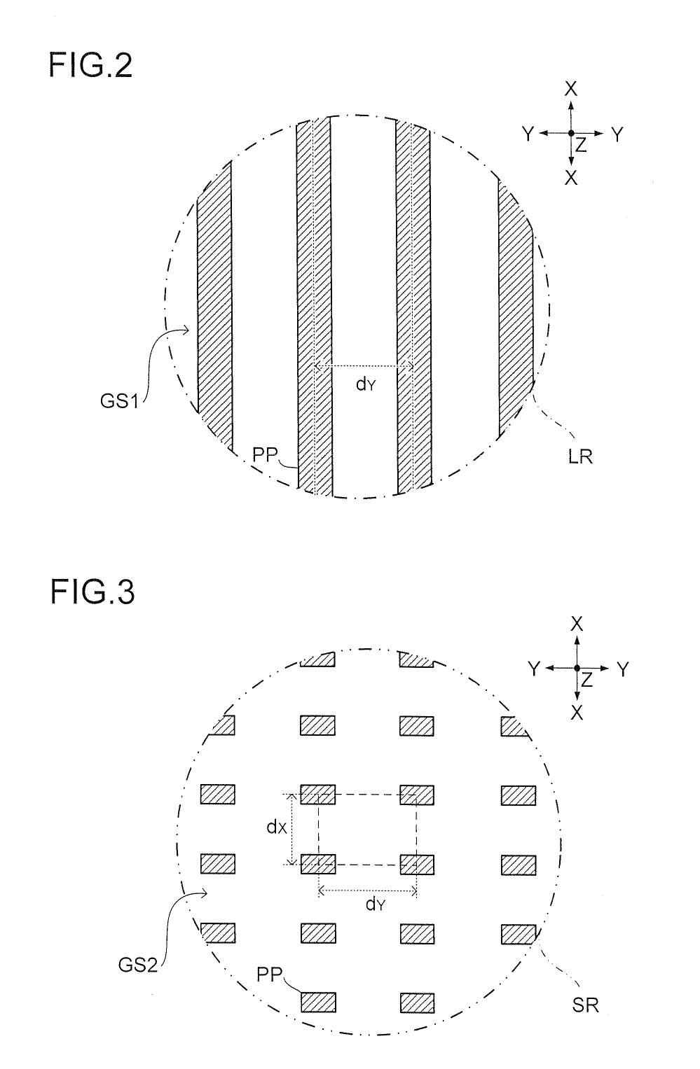

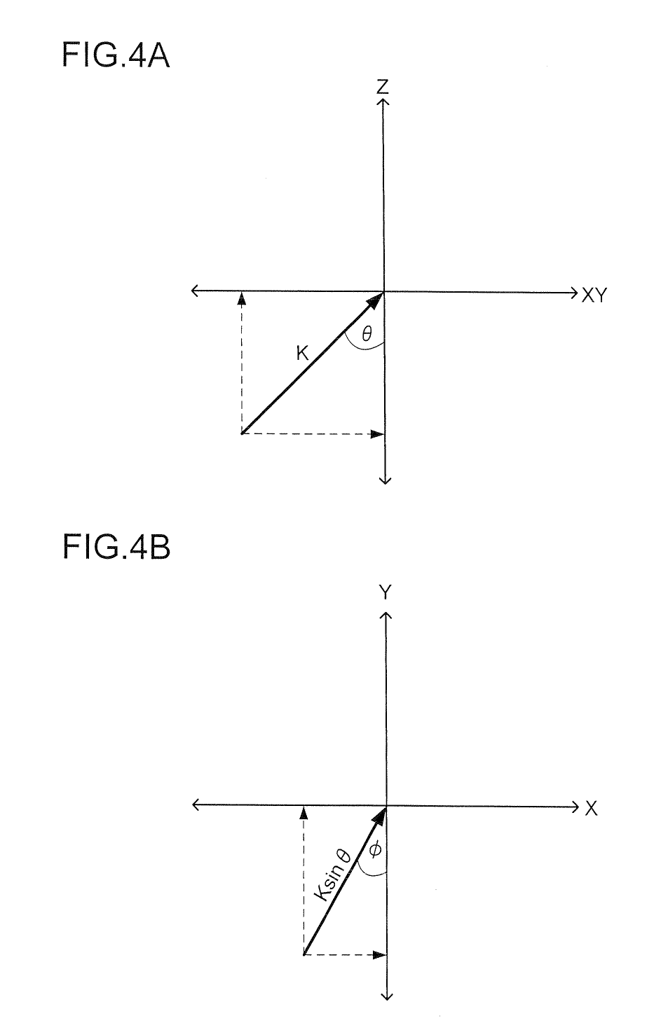

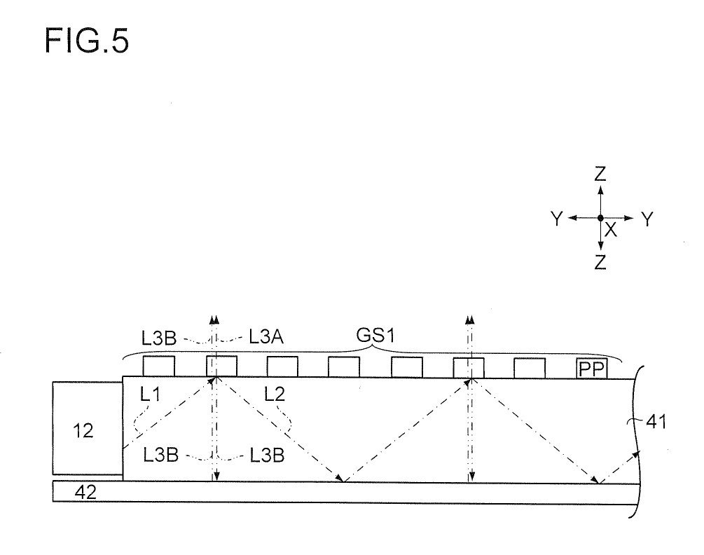

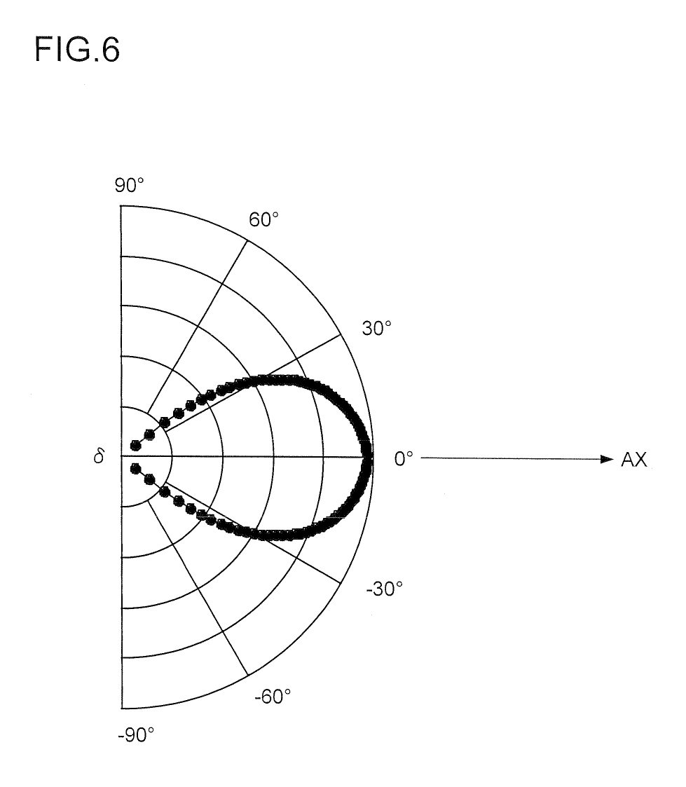

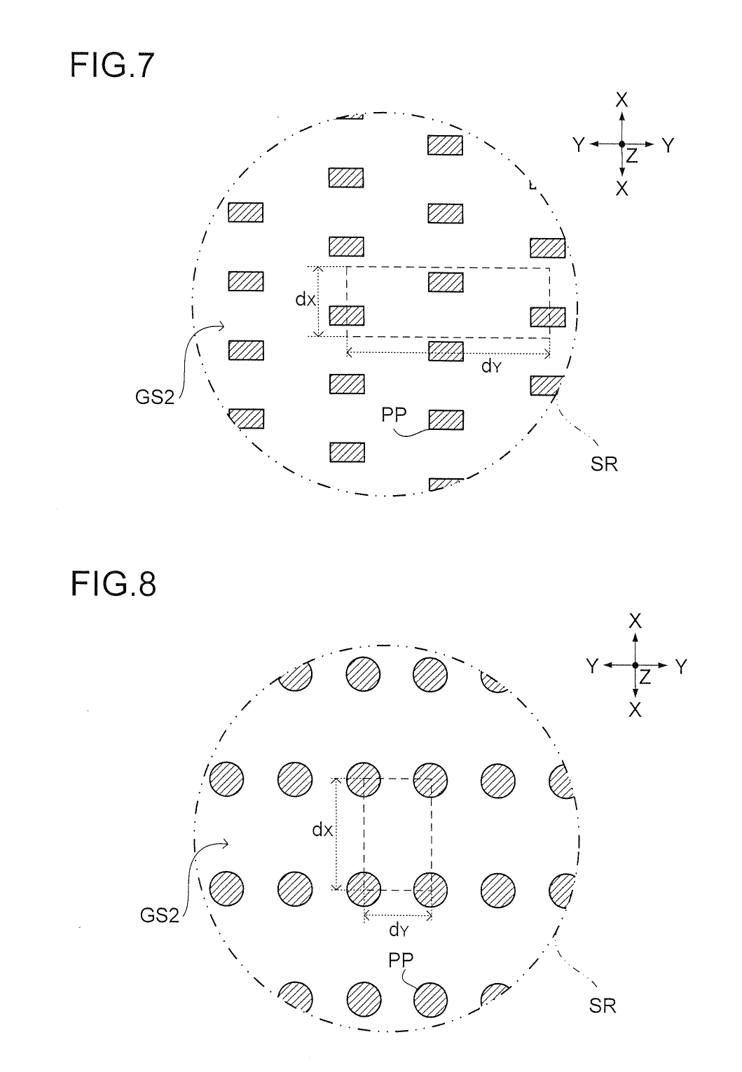

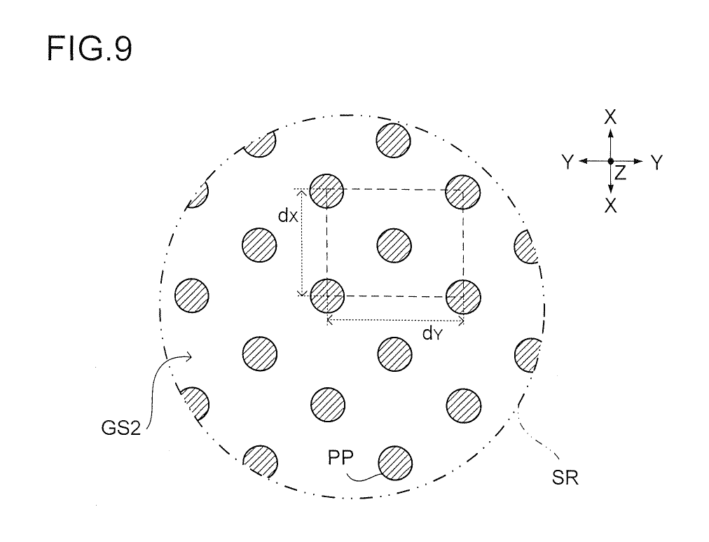

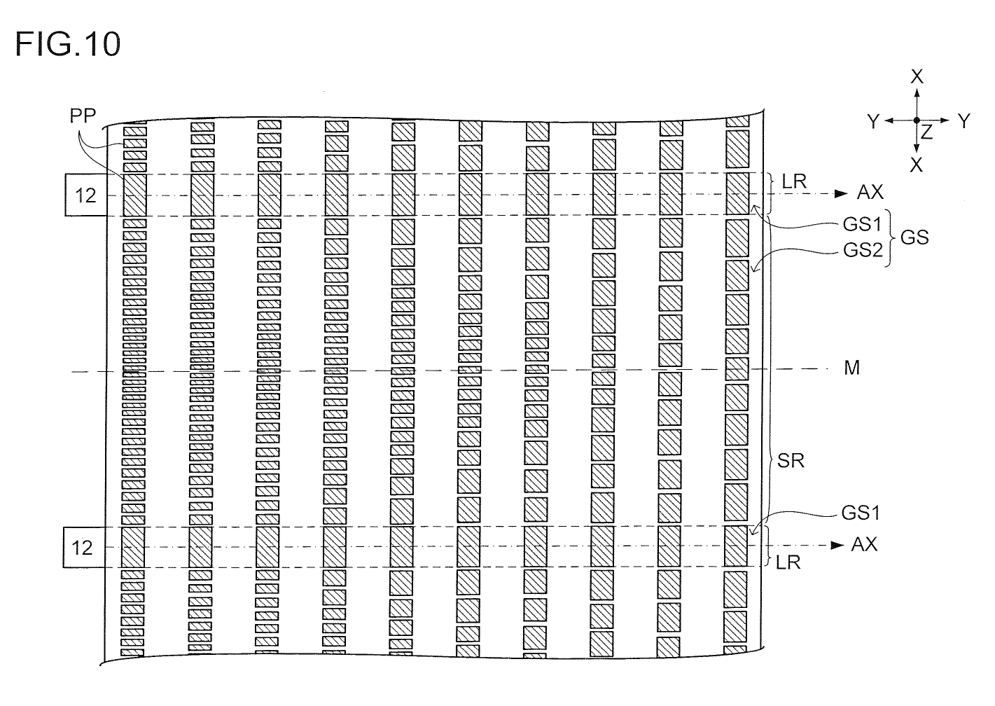

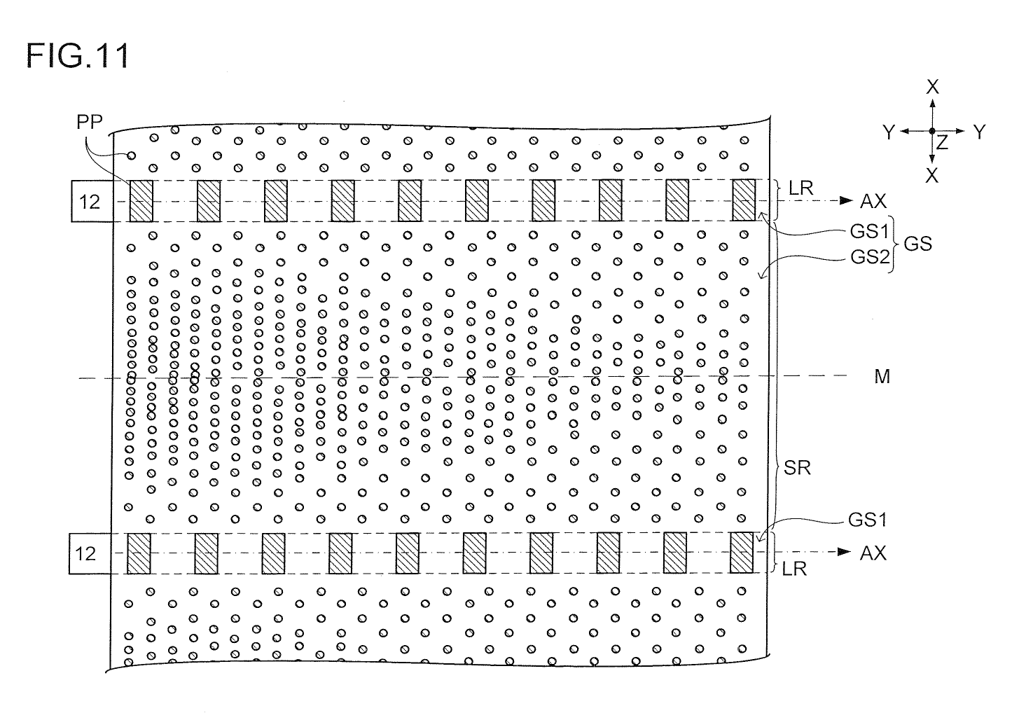

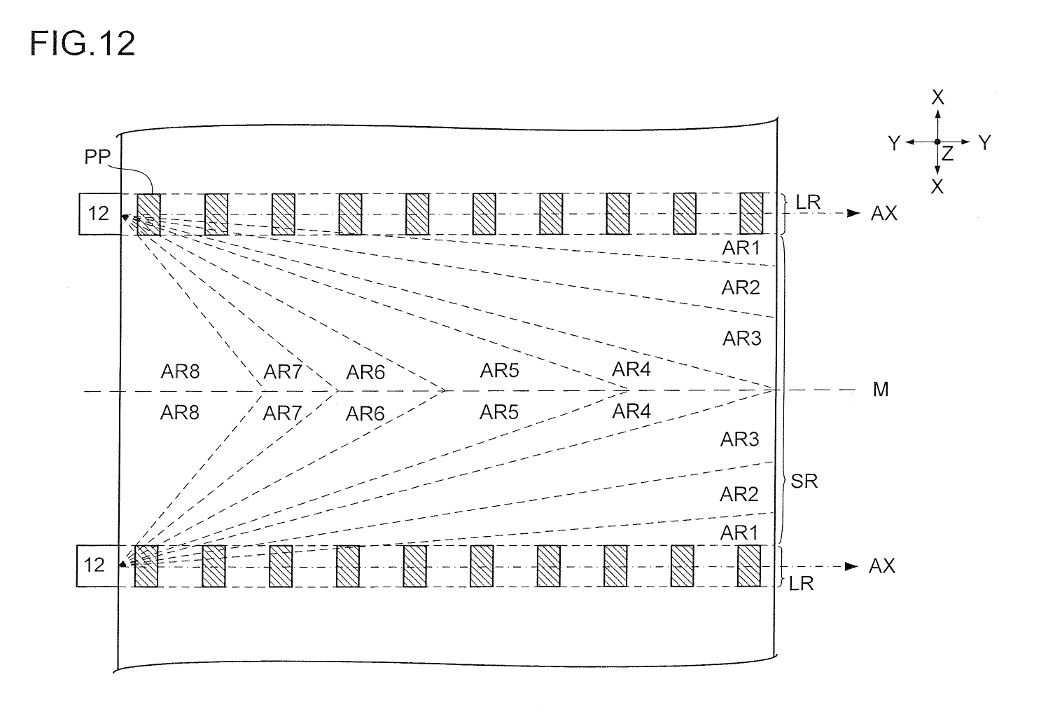

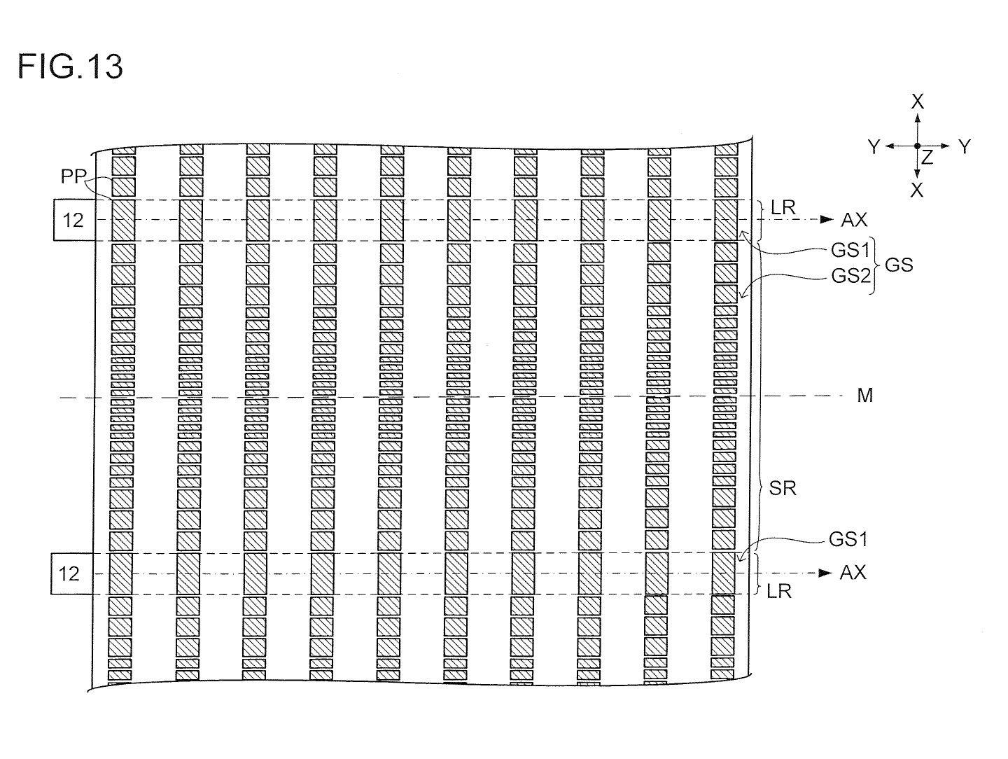

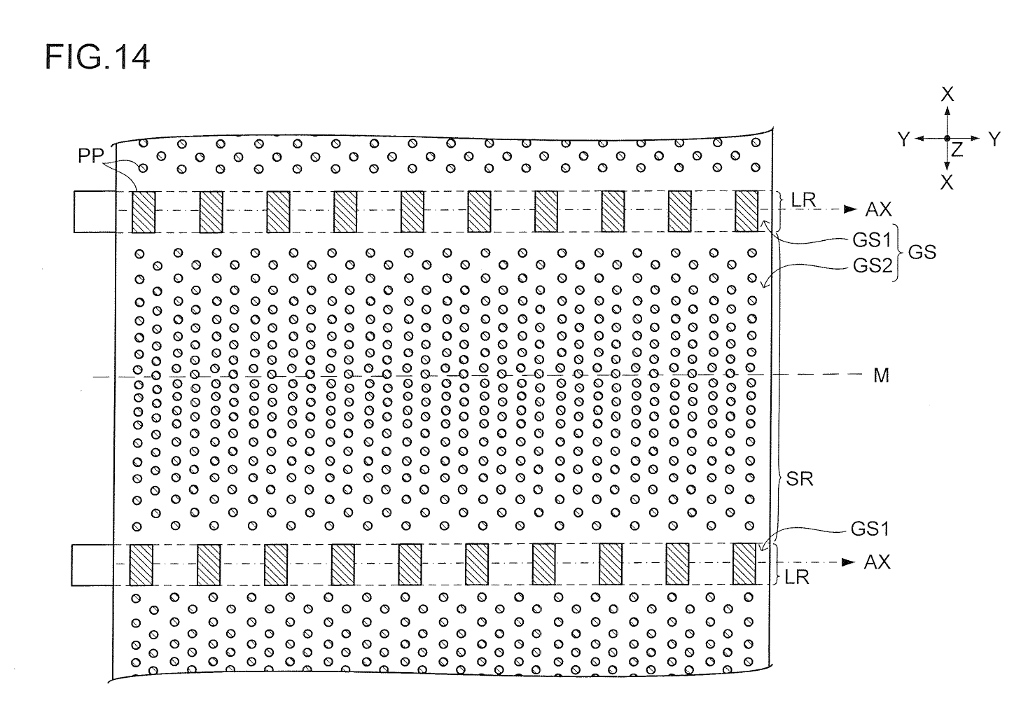

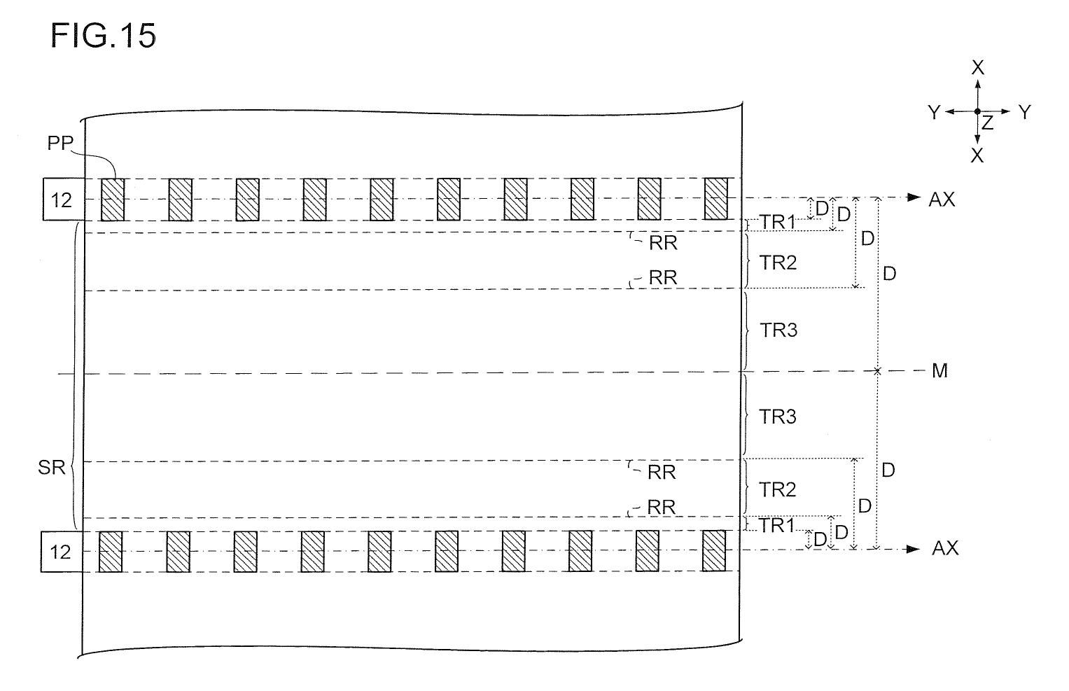

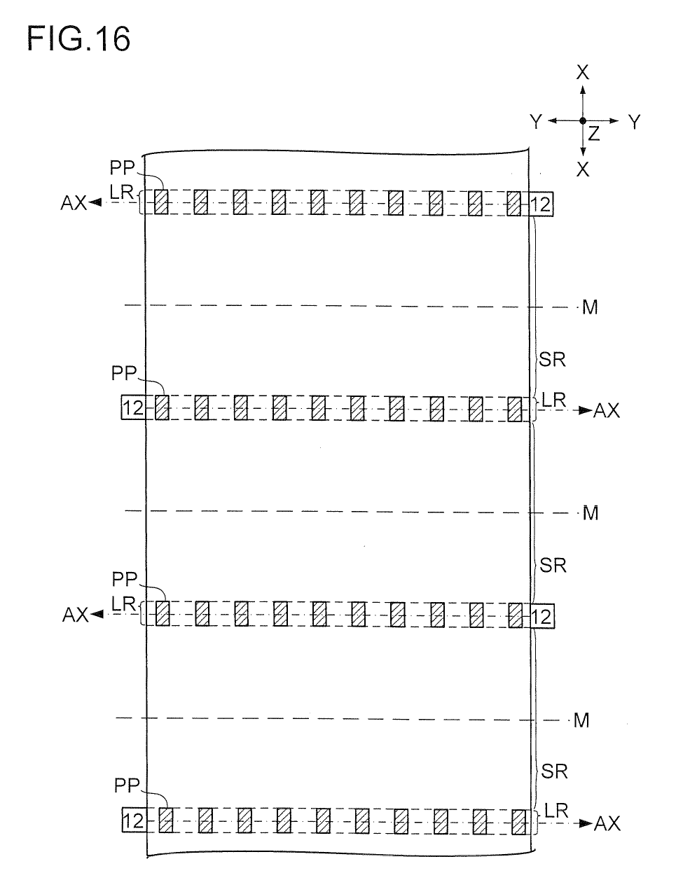

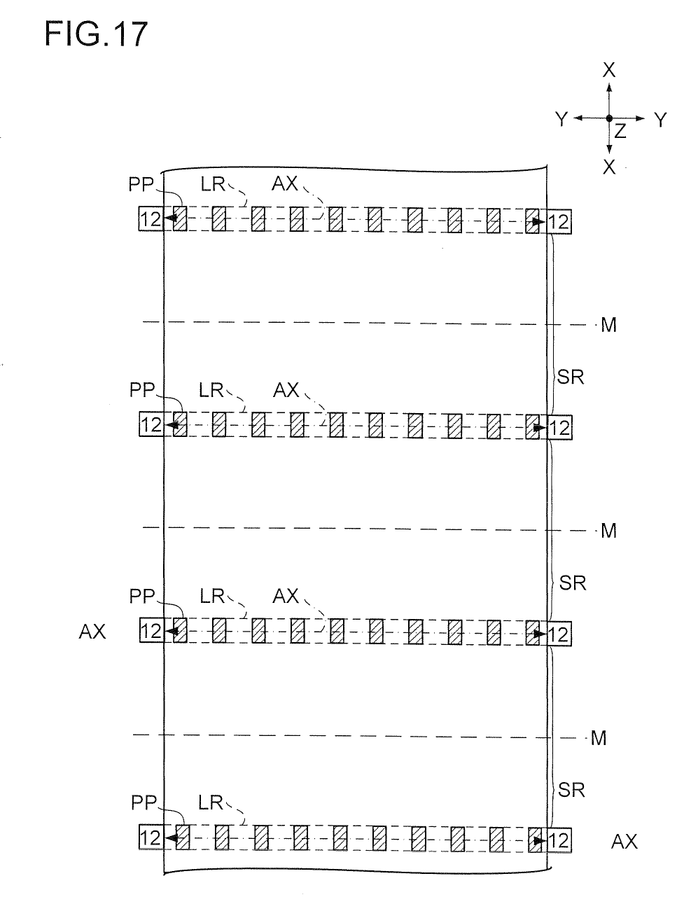

### BRIEF DESCRIPTION OF THE DRAWINGS

[FIG. 1] is an exploded perspective view of a liquid crystal display device.

[FIG. 2] is an enlarged plan view of a linear grating region of a light guide plate in a backlight unit.

[FIG. 3] is an enlarged plan view of a scattered grating region of a light guide plate in a backlight unit.

[FIG. 4A] is a vector diagram showing a wavenumber vector K in a rectangular-coordinates system that is composed of an XY-plane direction and a Z direction.

[FIG. 4B] is a vector diagram showing a wavenumber vector K in a rectangular-coordinates system that is composed of an X direction and a Y direction.

[FIG. 5] is a sectional view taken in the direction of A-A′ arrow lines in FIG. 1 (a reflection sheet, a light guide plate, and an LED module are chiefly shown).

[FIG. 6] is a distribution graph of luminous intensity of an LED.

[FIG. 7] is an enlarged plan view of a scattered grating region of a light guide plate showing another example of FIG. 3.

[FIG. 8] is an enlarged plan view of a scattered grating region of a light guide plate showing other examples of FIG. 3 and FIG. 7.

[FIG. 9] is an enlarged plan view of a scattered grating region of a light guide plate showing other examples of FIG. 3, FIG. 7 and FIG. 8.

[FIG. 10] is a simplified plan view of a diffraction grating surface formed of rectangular-parallelepiped grating pieces.

[FIG. 11] is a simplified plan view of a diffraction grating surface formed of circular-cylinder grating pieces.

[FIG. 12] is a simplified plan view showing chiefly divided regions (angle division regions AR) of scattered grating regions in FIG. 10 and FIG. 11.

[FIG. 13] is a simplified plan view of a diffraction grating surface formed of rectangular-parallelepiped grating pieces different from FIG. 10.

[FIG. 14] is a simplified plan view of a diffraction grating surface formed of circular-cylinder grating pieces different form FIG. 11.

[FIG. 15] is a simplified plan view showing chiefly divided regions (parallel division regions TR) of scattered grating regions in FIG. 13 and FIG. 14.

[FIG. 16] is a simplified plan view of a diffraction grating surface showing an example of an arrangement of LEDs.

[FIG. 17] is a simplified plan view of a diffraction grating surface showing an example of an arrangement of LEDs different from FIG. 16.

[FIG. 18] is a plan view of a top surface of a light guide plate incorporated in a conventional backlight unit.

### LIST OF REFERENCE SYMBOLS

[MJ] LED module
[11] mount board
[12] LED (light source)
[41] light guide plate
[41S] side surface of light guide plate (light reception surface/opposite surface)
[41B] bottom surface of light guide plate
[41U] top surface of light guide plate (output surface)
[GS] diffraction grating
[PP] grating piece
[LR] linear grating region (first region)
[SR] scattered grating region (second region)
[AR] angle division region
[TR] parallel division region
[RR] division line
[AX] optical-axis direction
[X] X direction (second direction)
[Y] Y direction (first direction)
[Z] Z direction
[42] reflection sheet
[49] backlight unit
[59] liquid crystal display panel
[69] liquid crystal display device

### BEST MODE FOR CARRYING OUT THE INVENTION

### Embodiment 1

An embodiment is described based on drawings as follows. Here, for convenience, there is a case where hatchings, member reference numbers and the like are omitted; in such a case, other drawings are referred to. Besides, a black dot in a drawing means a direction perpendicular to a paper surface.

FIG. 1 is an exploded perspective view of a liquid crystal display device 69. As show in this FIG. 1, the liquid crystal display device 69 includes a liquid crystal display panel 59 and a backlight unit 49.

The liquid crystal display panel 59 attaches an active matrix board 51 that includes switching elements such as a TFT (Thin Film Transistor) and the like and an opposite board 52 that faces the active matrix board 51 to each other by means of a seal material (not shown). And, liquid crystal (not shown) is injected into a gap between both boards 51, 52 (here, polarization films 53, 53 are so mounted as to sandwich the active matrix board 51 and the opposite board 52).

Because the liquid crystal display panel 59 is a non-light emitting type display panel, the liquid crystal display panel 59 performs a display function by receiving light (backlight) from the backlight unit 49. Because of this, if the light from the backlight unit 49 is able to evenly shine on the entire surface of the liquid crystal display panel 59, the display quality of the liquid crystal display panel 59 improves.

The backlight unit 49 includes: an LED module (light source module) MJ; a light guide plate 41; and a reflection sheet 42.

The LED module MJ is a module that emits light and includes: a mount board 11; and an LED (Light Emitting Diode) 12 that is mounted on an electrode formed on a mount surface of the mount board 11 and receives an electric current to emit light.

Besides, it is desirable that to secure an amount of light, the LED module MJ includes a plurality of LEDs (light emitting element, point light source) 12; moreover, it is desirable that the LEDs 12 are arranged into lines parallel to each other. However, in the drawing, for convenience, only part of the LEDs 12 are shown (incidentally, hereinafter, the direction in which the LEDs 12 are arranged is also called an X direction).

The light guide plate 41 is a plate-shape member that includes: a side surface 41S; a top surface 41U and a bottom surface 41B which are so situated as to sandwich the side surface 41S. And, a surface (light reception surface) of the side surface 41S faces a light emitting end of the LED 12 to receive the light from the LED 12. The received light undergoes mixing (multiple reflection) in the inside of the light guide plate 41 and is output as area light from the top surface (output surface) 41U to outside.

The reflection sheet 42 is so situated as to be covered by the light guide plate 41. And, a surface of the reflection sheet 42 that faces the bottom surface 41B of the light guide plate 41 serves as a reflection surface. Because of this, this reflection surface reflects, without leaking, the light from the LED 12 and the light propagating in the inside of the light guide plate 41 back into the light guide plate 41 (in detail, via the bottom surface 41B of the light guide plate 41).

Here, in the above backlight unit 49, the reflection sheet 42 and the light guide plate 41 are piled up in this order (here, the piled-up direction is also called a Z direction and a direction perpendicular to the X direction and the Z direction is also called a Y direction). And, the light from the LED 12 is formed into the area light (backlight) by the light guide plate 42 and output; the area light reaches the liquid crystal display panel 59; and by means of the area light, the liquid crystal display panel 59 displays an image.

Here, the light guide plate 41 of the backlight unit 49 is described in detail. First, the light guide plate 41 is so disposed as to correspond to the three orthogonal directions (XYZ directions).

Specifically, the X direction corresponds to a long-edge direction of the light reception surface 41S of the light guide plate 41 that faces the LED module MJ (the X direction is also a parallel direction of the LED 12). Besides, the Y direction corresponds to a shortest-edge direction from the light reception surface 41S to the side surface (opposite surface) 41S of the light guide plate 41 that is so disposed as to be opposite to the light reception surface 41S. Besides, the Z direction is a thickness direction of the light guide plate 41 (the Z direction is also a direction in which various members such as the light guide plate 41 and the like are piled up).

And, on the top surface 41U of the light guide plate 41, diffraction gratings GS (GS1, GS2) are formed. This diffraction grating GS includes two kinds of regions LR, SR. The linear grating region LR which is one region, on the top surface 41U of the light guide plate 41, extends along the Y direction (first direction) from a place with which the light emitting end of the LED 12 faces (accordingly, an optical-axis direction AX of the LED 12 and the Y direction are the same directions as each other).

The scattered grating region SR which is the other region, on the top surface 41U of the light guide plate 41, extends along the Y direction from a place with which a surface between the LEDs 12 faces. In short, on the top surface 41U of the light guide plate 41, the region other than the linear grating region LR is the scattered grating region SR.

And, the linear grating region (first region) LR, as shown in FIG. 2 that is an enlarged plan view of a dash-dotted circle in FIG. 1, arranges linear grating pieces PP that extend in the X direction to be parallel to each other along the Y direction (arranges the grating pieces PP one dimensionally). On the other hand, the scattered grating region (second region) SR, as shown in FIG. 3 that is an enlarged plan view of a two-dot-one-bar circle in FIG. 1, arranges dot-shape grating pieces PP two dimensionally (the X direction and the Y direction).

Although the top surface 41U of the light guide plate 41 that includes the two kinds of grating regions LR, SR is a diffraction grating surface 41U, a three-dimensional diffraction phenomenon based on this diffraction grating surface 41U is able to be expressed by the following formulas (A1) and (A2) (here, the top surface 41U is also an XY plane defined by the X direction and the Y direction).

n2·sin θ2·sin φ2=n1·sin θ1·sin φ1+mX·λ/dX (A1)

n2·sin θ2·cos φ2=n1·sin θ1·cos φ1+mY·λ/dY (A2)

where
n1: the refractive index of a medium on an incident side to the top surface 41U (B1)
θ1: the angle at the top surface 41U formed between the incident light to the top surface 41U and the Y direction (B2)
φ1: the incident angle to the top surface 41U (B3)
n2: the refractive index of a medium on an output side to the top surface 41U (B4)
θ2: the angle at the top surface 41U formed between the output light from the top surface 41U and the Y direction (B5)
φ2: the output angle to the top surface 41U (B6)
dX: the periodic interval in the X direction of the diffraction grating GS (B7)
dY: the periodic interval in the Y direction of the diffraction grating GS (B8)
mX: the diffraction degree in the X direction (B9)
mY: the diffraction degree in the Y direction (B10)
λ: the wavelength of light (B12)

Here, in detail, the formulas (A1) and (A2) are obtained as follows (see FIG. 4A and FIG. 4B).

First, the propagating light is considered as a vector, that is, a wavenumber vector K. This wavenumber vector K is represented as shown in FIG. 4A in a coordinates system that uses the Z direction and the XY-plane direction. And, in this coordinates system, if it is supposed that the angle formed between the wavenumber vector K and the Z direction is θ, a Z-direction component and an XY-plane-direction component of the wavenumber vector K are as follows.

the Z-direction component: K·cos θ (C1)

the XY-plane-direction component: K·sin θ (C2)

Moreover, the wavenumber vector K is represented as shown in FIG. 4B in a coordinates system that uses the X direction and the Y direction. And, in this coordinates system, if it is supposed that the angle formed between the wavenumber vector K and the Y direction is “φ”, an X-direction component and a Y-direction component of K·sin θ that is the XY-plane component of the wavenumber vector K are as follows.

the X-direction component: K·sin θ·sin φ (C3)

the Y-direction component: K·sin θ·cos φ (C4)

Here, according to the wavenumber conservation laws, neglecting the Z-direction component, the wavenumber vector K is denoted by a vector (X-direction component, Y-direction component) as follows.

K=(K·sin θ·sin φ,K·sin θ·cos φ) (C5)

Moreover, the wavenumber vector K in a medium is expressed by the refractive index n of the medium and the wavelength of light as follows.

K=n/λ (C6)

Therefore, the wavenumber vector K is expressed from (C5) and (C6) by a vector as follows.

K=(n/λ·sin θ·sin φ,n/λ·sin θ·cos φ) (C7)

And, when light before diffraction by a diffraction grating surface (XY plane) is a wavenumber vector K1, light diffracted by the diffraction grating surface is a wavenumber vector K2, and a vector (diffraction vector) of the diffraction grating GS that causes the diffraction is G, the following relationship is obtained.

K2=K1+G (C8)

Here, the diffraction vector G is obtained from the periodic interval “d” of the diffraction grating GS and the diffraction degree “m” as follows.

G=m/d (C9)

Taking the above description into account, by using (C7) to (C9) and (B1) to (B12), the vector denotations of the wavenumber vector K1, the wavenumber vector K2, and the diffraction vector G are represented by the following (D1) to (D3), and the formula (A1) and the formula (A2) are obtained.

K1=(n1/λ·sin θ1·sin φ1,n1/λ·sin θ1·cos φ1) (D1)

K2=(n2/λ·sin θ2·sin φ2,n2/λ·sin θ2·cos φ2) (D2)

G=(mX/dX,mY/dY) (D3)

And, if the formula (A1) and the formula (A2) are used to appropriately design the diffraction grating GS, the diffraction grating GS is able to make the light output from the top surface 41U of the light guide plate 41 propagate (go) in a desired direction. For example, as shown in FIG. 5 that is a sectional view on the YZ plane and represents the linear grating region LR, the light is able to propagate (here, it is also possible to say that FIG. 5 shows the light which propagates in the Y direction). Here, in the following description, there is a case where light is expressed by means of the diffraction degrees (mX, mY). Besides, there is a case where the light coming out of the light guide plate 41 is expressed as transmitted light, while the light reflected in the inside of the light guide plate 41 is expressed as reflected light.

As shown in FIG. 5, when light L1 coming out of the LED 12 reaches the diffraction grating surface 41U of the top surface 41U, light L2 that is not diffracted, that is, the light [(0, 0)-degree reflected light] that is simply reflected and light L3 (diffracted transmitted light L3A, diffracted reflected light L3B) that is diffracted occur.

In order for the diffracted transmitted light L3A to pass and go through in a direction (normal direction) substantially perpendicular to the top surface 41U and moreover to obtain a relatively high light intensity, it is desirable that the diffracted transmitted light L3A is (0,−1)-degree diffracted transmitted light (i.e., it is desirable that (mX, mY)=(0,−1)). Besides, the refractive index is decided from a material of the light guide plate 41 and the air.

Then, a parameter that is fixed and a parameter that varies mingle in the formula (A2); by changing the varying parameter, the periodic interval dY of the diffraction grating GS1 in the Y direction is obtained.

For example, in a case where the material of the light guide plate 41 is polycarbonate and the refractive index (n1) of the material is about “1.58” (incidentally, the refractive index of the air is “1”), if the periodic interval dY of the diffraction grating GS in the Y direction is “400 nm,” the (0,−1)-degree diffracted transmitted light occurs in the linear grating region LR in a large quantity.

Besides, according to such a periodic interval, the (0,−1)-degree diffracted reflected light L3B also occurs (here, in this case, the refractive indices n1, n2 are the refractive indices of the light guide plate 41). And, this diffracted reflected light L3B is reflected and goes in a direction (normal direction) substantially perpendicular to the top surface 41U. Then, the diffracted reflected light L3B is not totally reflected at the bottom surface 41B of the light guide plate 41, passes through the bottom surface 41B and reaches the reflection sheet 42. Then, the reaching light is reflected by the reflection sheet 42, returns from the bottom surface 41B, goes to the top surface 41U and further perpendicularly goes out to outside as it is.

On the other hand, even if light reaches the scattered grating region SR of the top surface 41U, light that is not diffracted and light that is diffracted (diffracted transmitted light, diffracted reflected light) occur. And, it is desirable that, of the diffracted light, the diffracted transmitted light, like the diffracted transmitted light L3A in FIG. 5, passes and goes in a direction substantially perpendicular to the top surface 41U.

To generate diffracted transmitted light that passes and goes in a direction substantially perpendicular to the scattered grating region SR of the top surface 41U, it depends on how incident light having an angle (incident angle φ1) to the top surface 41U of the scattered grating region SR is diffracted. For example, in a case where light having the incident angle φ1 that is not “0°” undergoes the (0, −1)-degree diffraction, it is clear from the formula (A1) that the wavenumber vector K2 of the diffracted light has an X-direction component. This means that the light which is diffracted by the scattered grating region SR of the top surface 41U and passes through becomes oblique by the X-direction component to the X direction of the top surface 41U.

However, in a case where light having the incident angle φ1 that is not “0°” undergoes (−1,−1)-degree diffraction, from the formula (A1), the X-direction component of the wavenumber vector K2 of the diffracted light is represented as “n1/λ·sin θ1·sin φ1−1/d X.” Then, if the periodic interval dX of the diffraction grating GS2 in the X direction is appropriately set, the X-direction component of the wavenumber vector K2 is “0,” that is, the light which is diffracted by the scattered grating region SR of the top surface 41U and passes through becomes substantially perpendicular to the X direction of the top surface 41U. In other words, this light is the diffracted transmitted light that passes and goes in a direction substantially perpendicular to the scattered grating region SR of the top surface 41U.

Here, in part of the diffracted reflected light that is diffracted by the diffracted grating GS2 of the scattered grating region SR, the incident angle to the bottom surface 41B of the light guide plate 41 does not exceed an critical angle. Because of this, such part of the diffracted reflected light is not totally reflected at the bottom surface of the light guide plate 41 and passes through the bottom surface 41B. And, the passing-through light is reflected by the reflection sheet 42 that covers the bottom surface 41B, returns from the bottom surface 41B, goes to the top surface 41U and further perpendicularly goes out to outside as it is.

From the above description, it is possible to say about the light guide plate 41 as follows. Specifically, the diffraction grating GS of the top surface 41U of the light guide plate 41, in accordance with luminous-intensity distribution of the LED 12 shown in FIG. 6, includes two kinds of regions (the linear grating region LR having a one-dimensional diffraction grating G1 and the scattered grating region SR having a two-dimensional diffraction grating G2).

In detail, in a case where light propagating in the optical-axis direction AX of the LED 12 in FIG. 6 propagates along the Y direction via the light reception surface 41S of the light guide plate 41, an arrival portion of the top surface 41U where the light reaches serves as the linear grating region LR. On the other hand, in a case where light deviating from the optical-axis direction AX of the LED 12 in FIG. 6 and propagating deviates from the Y direction as well and propagates via the light reception surface 41S of the light guide plate 41, an arrival portion of the top surface 41U where the light reaches serves as the scattered grating region SR.

And, because grating pieces PP are arranged in the linear grating region LR along the Y direction, the diffraction vector G has the same direction as the Y direction (see FIG. 2). And, because most of the light that reaches the linear grating region LR is also the light that propagates along the Y direction, the light propagating along the Y direction is efficiently diffracted by the diffraction grating GS1 that has the diffraction vector G in the Y-direction (i.e., the diffraction grating GS1 of the linear grating region LR generates the diffraction vector G that matches the Y direction which is the propagation direction of the light, thereby increasing the matching possibility and efficiently diffracting the light).

In addition, if the direction of the diffraction vector G and the propagation direction (going direction) of the light match each other, the (0,−1)-degree diffracted transmitted light L3A shown in FIG. 5 is generated relatively easily. Because of this, the light, which comes out in a direction substantially perpendicular to the top surface 41U that includes the linear grating region LR, is generated in a large quantity.

On the other hand, because the grating pieces PP are scattered and arranged in the scattered grating region SR, the diffraction vector G does not match the Y direction. In other words, in this scattered grating region SR, various-direction diffraction vectors G occur. Because of this, the possibility that the propagation direction of the light (deviating light), that is, the light which reaches the linear grating region LR and does not match the Y direction matches the direction of the diffraction vector G increases, so that the diffraction efficiency becomes high. In other words, the diffraction grating GS2 of the scattered grating region SR generates the diffraction vector G that matches the propagation direction of the deviating light, thereby increasing the matching possibility and efficiently diffracting the light.

In addition, if the diffraction vector G and the propagation direction of the light match each other in the scattered grating region SR, the (−1,−1)-degree diffracted transmitted light is generated relatively easily. Because of this, the light, which comes out in a direction substantially perpendicular to the top surface 41U that includes the scattered grating region SR, is generated in a large quantity.

In other words, the top surface 41U (the diffraction grating surface 41U) of the light guide plate 41, in accordance with the propagation direction of the light from the LED 12, includes a plurality kinds of diffraction gratings GS (the one-dimensional diffraction grating GS1 and the two-dimensional diffraction grating GS2). And, in the linear grating region LR that is the region in which the one-dimensional diffraction grating GS1 is included, the propagating light is efficiently diffracted by the diffraction grating GS1 that generates the diffraction vector G which matches the propagation direction of the light that reaches the region LR.

Also, in the scattered grating region SR that is the region in which the two-dimensional diffraction grating GS2 is included, the propagating light is efficiently diffracted by the diffraction grating GS2 that generates the diffraction vector G which matches the propagation direction of the light that reaches the region SR.

And, if the light that is diffracted and passes through the top surface 41U that includes the linear grating region LR and the scattered grating region SR is light substantially perpendicular to the top surface 41U, an optical sheet group of the diffusion sheet, the prism sheet and the like do not need to cover the top surface 41U of the light guide plate 41. Accordingly, the number of components of the backlight unit 49 is reduced and the cost reduction is achieved. Besides, if an optical sheet group does not cover the top surface 41U of the light guide plate 41, the thickness of the backlight unit 49 becomes thin.

Here, the arrangement pattern (grating pattern) of the grating pieces PP is not limited to an orthogonal grating shape (quadrangular arrangement of the grating pieces PP) shown in FIG. 3. For example, as shown in FIG. 7, the arrangement of the grating pieces PP may be a six-direction grating shape (hexagonal-shape arrangement of the grating pieces PP). In short, in a case where characteristics of the diffraction efficiency such as incident-angle dependency and the like must change to increase the output efficiency of light from the light guide plate 41, in accordance with which the arrangement of the grating pieces PP may suitably change (here, FIG. 3 and FIG. 7 are examples of a polygonal-shape arrangement of the grating pieces PP; and another shape other than the polygonal shape may be employed).

Besides, also, the shape of the grating piece PP itself is not especially limited. Specifically, the grating pieces PP that are each a rectangular post body (rectangular parallelepiped) may not be arranged into the orthogonal grating shape and the six-direction grating shape. For example, as shown in FIG. 8 and FIG. 9, the grating pieces PP that are each a circular post body (circular cylinder) may be arranged into the orthogonal grating shape and the six-direction grating shape. In short, like the above description, the shape of the grating pieces PP may suitably change to increase the output efficiency of light from the light guide plate 41.

Here, for example, for increase in the diffraction efficiency or thickness reduction of the light guide plate 41, the periodic interval dX, the periodic interval dY, the ratio W/V of the width W of the grating piece PP in every direction of the X direction and the Y direction to the distance V between the grating pieces PP, and the height H of the grating piece PP that is a length of the grating piece PP in the Z direction are set in the following range. Here, in FIG. 3 and FIG. 7 to FIG. 9, portions enclosed by broken lines are each able to be called a unit cell that generates the diffraction vector G.

0.1 μm≦dX≦1.0 μm

0.1 μm≦dY≦1.0 μm

1/9≦W/V≦9/1 (where W/V is the ratio in every direction of the X direction and Y direction)

100 nm≦H≦1000 nm

Next, a specific example of the diffraction grating surface 41U is described by means of simplified plan views in FIG. 10 to FIG. 12. FIG. 10 is a simplified plan view of the diffraction grating surface 41U formed of the rectangular-parallelepiped grating pieces PP; FIG. 11 is a simplified plan view of the diffraction grating surface 41U formed of the circular-cylinder grating pieces PP. FIG. 12 is a simplified plan view showing chiefly divided regions (angle division regions AR) of the scattered grating regions SR in FIG. 10 and FIG. 11. Here, in the figures, a line, which divides the scattered grating region SR into two portions by equally dividing a region between the LED 12 and the LED 12 parallel to each other, is a two-division line M.

As shown in FIG. 10 and FIG. 11, in the linear grating region LR, the grating pieces PP are arranged along the Y direction, so that the one-dimensional diffraction grating GS1 is formed. On the other hand, in the scattered grating region SR, the grating pieces PP are scattered and arranged on the XY plane, so that the two-dimensional diffraction grating GS2 is formed.

However, in the scattered grating region SR, the periodic interval dY of the diffraction grating GS2 in the Y direction is constant; but the periodic interval dx of the diffraction grating GS2 in the X direction (second direction) is not constant. In detail, the scattered gating region SR is divided into regions in accordance with the divergence angle δ of light at the LED 12 and the periodic interval dx is different for every one of the divided regions (angle division region AR).

Here, the divergence angle δ, as shown in FIG. 6, is an angle formed between the optical-axis direction (direction in which light from the LED 12 propagates in the largest quantity: average propagation direction) and light from the LED 12. In other words, it is also possible to say that the divergence angle δ indicates how much the light deviating from the optical-axis direction AX and propagating deviates in angle with respect to the optical-axis direction AX.

And, in accordance with an angle range of the divergence angle δ, the scattered grating region SR is divided into the angle division regions AR. In detail, the scattered grating region SR is divided into two portions by the two-division line M that divides a place between the LEDs 12; and a region where the two-divided scattered grating region SR and the light propagating at the divergence angle δ in a predetermined range overlap each other is the angle division region AR.

For example, the diffraction grating GS2 shown in FIG. 10 and FIG. 11 has a different periodic interval dx for every one of the angle division regions AR shown in FIG. 12. Especially, the smaller a lower limit value of the angle range in the angle division region AR is, the longer the periodic interval dx in the angle division region AR becomes (here, the periodic interval dx changes in accordance with the incident angle φ1 to the top surface 41U, so that the (−1,−1)-degree diffracted reflected light, which goes out in a direction substantially perpendicular to the top surface 41U that includes the scattered grating region SR, is generated).

Here, the angle ranges of the divergence angle δ in the angle division regions AR1 to AR8 and examples of the periodic interval dx in the angle division regions AR1 to AR8 are as follows (here, it is desirable that the periodic interval dx is set in a range of 100 nm or longer to 5000 nm or shorter).

angle division region AR1: 0°≦δ≦5°, dx=4500 nm

angle division region AR2: 5°<δ≦10°, dx=2500 nm

angle division region AR3: 10°<δ≦15°, dx=1500 nm

angle division region AR4: 15°<δ≦20°, dx=1200 nm

angle division region AR5: 20°<δ≦30°, dx=800 nm

angle division region AR6: 30°<δ≦40°, dx=600 nm

angle division region AR7: 40°<δ≦50°, dx=500 nm

angle division region AR8: 50°<δ≦90°, dx=400 nm

According to this, in the scattered grating region SR, there are a plurality of periodic intervals dX of the diffraction grating GS2. Because of this, in accordance with the various periodic intervals dX and the constant periodic interval dY, many kinds of diffraction vectors G occur and the diffraction vectors G correspond to many kinds of propagations of light, so that the diffracted light is efficiently generated. Of course, it is also possible to generate the diffracted transmitted light substantially perpendicular to the top surface 41U that includes the scattered grating region SR.

Here, the way of dividing the scattered grating region SR is not limited to the divergence angle δ only. Because of this, other examples of the way of dividing the scattered grating region SR are described by means of FIG. 13 to FIG. 15.

FIG. 13 is a simplified plan view of the diffraction grating surface 41U formed of the rectangular-parallelepiped grating pieces PP; and FIG. 14 is a simplified plan view of the diffraction grating surface 41U formed of the circular-cylinder grating pieces PP. FIG. 15 is a simplified plan view showing chiefly the divided regions (parallel division regions TR) of the scattered grating region SR in FIG. 13 and FIG. 14.

As shown in FIG. 13 to FIG. 15, division lines RR having the same direction as the optical-axis direction AX are arranged along the X direction, so that the scattered grating region SR is divided into regions and the divided regions are parallel division regions TR. In detail, the division lines RR are arranged at different distances (distance D) from the optical-axis direction AX of the LED 12 along the X direction, so that the scattered grating region SR is divided.

Here, the distance D is the shortest interval between the optical-axis direction AX of the LED 12 closest to the parallel division region TR and the parallel division region TR. Because of this, if the two-division line M divides equally the region between the LEDs 12, there is no distance D that exceeds the shortest distance from the two-division line M to the optical-axis direction AX.

And, the periodic interval dx is different for every one of the parallel division regions TR sandwiched by division lines RR that have different distances D. Especially, the shorter the shortest distance D at the parallel division region TR is, the longer the periodic interval dx in the parallel division region TR becomes (of course, in accordance with the incident angle φ1 to the top surface 41U, the periodic interval dx changes, so that it is also possible to generate the (−1,−1)-degree diffracted reflected light which goes out in a direction substantially perpendicular to the top surface 41U that includes the scattered grating region SR).

Here, ranges of the shortest distance D to the longest distance D in the parallel division regions TR1 to TR3 and examples of the periodic interval dx in the parallel division regions TR1 to TR3 are as follows (here, it is desirable that the periodic interval dx is set in a range of 100 nm or longer to 5000 nm or shorter).

parallel division region TR1: 400 μm≦D≦500 μm, dx=2500 nm

parallel division region TR2: 500 μm<D≦1500 μm, dx=1500 nm

parallel division region TR3: 1500 μm<D≦5000 μm, dx=800 nm

According to this, like in the case of the angle division region AR, in the scattered grating region SR, there are a plurality of periodic intervals dX of the diffraction grating GS2. Because of this, in accordance with the various periodic intervals dX and the constant periodic interval dY, many kinds of diffraction vectors G occur and the diffraction vectors G correspond to many kinds of propagations of light, so that the diffracted light is efficiently generated.

### Other Embodiments

Here, the present invention is not limited to the above embodiments; and various modifications are possible without departing from the spirit of the present invention.

For example, the above backlight unit 49 is of a side-light type in which the LED module MJ faces only one side surface 41S of the light guide plate 41. However, this is not limiting. For example, the backlight unit 49 may be employed, in which the LED module MJ faces the two side surfaces 41S, 41S of the light guide plate 41 that are opposite to each other.

In detail, as shown in FIG. 16, in adjacent linear grating regions LR, the LEDs 12 corresponding to the linear grating regions LR may not face the same side surface 41S. In other words, the LEDs 12 corresponding to the adjacent linear grating regions LR may be opposite to each other. Besides, as shown in FIG. 17, the LEDs 12 may be situated to correspond to both ends of the linear grating region LR in the Y direction.

Here, even in the arrangement shown in FIG. 16 or FIG. 17, the scattered grating region SR is divided by the parallel division region TR shown in FIG. 13 and FIG. 14, the light form the LED 12 efficiently becomes the diffracted light.

Besides, the way of forming the diffraction grating GS of the top surface 41U of the light guide plate 41 is not especially limited. For example, a nano-imprint technology may be used, in which the pattern of the diffraction grating GS is transferred onto the top surface 41U of the light guide plate 41 by means of a press tool.

1. A backlight unit that has:
a light source; and
a light guide plate that receives light from the light source, makes the light undergo multiple reflection and outputs the light to outside; wherein
in the light guide plate, a surface that receives the light is a light reception surface, a surface disposed opposite to the light reception surface is an opposite surface, a surface that outputs the light to outside is an output surface, and a shortest direction from the light reception surface to the opposite surface is a first direction;
a diffraction grating is formed on the output surface;
in the diffraction grating, a first region that makes a diffraction vector having a same direction as the first direction occur and a second region that makes a diffraction vector having a direction different from the first direction occur are included;
the first region is situated at an arrival portion of the output surface where light that propagates along the first direction reaches; and
the second region is situated at an arrival portion of the output portion where light that deviates from the first direction and propagates reaches.

2. The backlight unit according to claim 1, wherein
the first region is, on the output surface, situated, along the first direction, from a place that faces a light emitting end of the light source; and
the second region is, on the output surface, situated in a place other than the first region.

3. The backlight unit according to claim 1, wherein the diffraction grating in the second region has a polygonal-shape grating pattern.

4. The backlight unit according to claim 3, wherein the grating pattern is a quadrangular-shape grating pattern or a hexagonal-shape grating pattern.

5. The backlight unit according to claim 1, wherein a grating piece that constitutes the diffraction grating is a post body.

6. The backlight unit according to claim 5, wherein the post body is a rectangular parallelepiped or a circular cylinder.

7. The backlight unit according to claim 1 wherein the diffraction grating in the second region includes two or more kinds of periodic intervals in a second direction that is a direction which intersects the first direction.

8. The backlight unit according to claim 7, wherein on the output surface, an angle formed between an optical-axis direction of the light source that matches the first direction and the light from the light source is a divergence angle, and the second region is divided into regions in an angle range of the divergence angle and the divided regions are angle division regions; wherein in the diffraction grating in every one of the angle division regions, the smaller a lower limit value of the angle range is, the longer the periodic interval in the second direction that is the direction which intersects the first direction is.

9. The backlight unit according to claim 7, wherein an optical-axis direction of the light source matches the first direction;
a division line that has a same direction as the first direction is arranged on the second region along the second direction that is the direction which intersects the first direction, so that at least a portion of the second region is divided into regions and the divided regions are parallel division regions; wherein
in the diffraction grating in every one of the parallel division regions, the shorter a shortest distance between the optical-axis direction of the light source closest to the parallel division region and the parallel division region is, the longer the periodic interval in the second direction is.

10. The backlight unit according to claim 1, wherein a bottom surface of the light guide plate that is a surface disposed to be opposite to the output surface is covered by a reflection sheet that guides light leaking from the bottom surface into the light guide plate.

11. A liquid crystal display device comprising:
the backlight unit according to claim 1; and
a liquid crystal display panel that receives light from the backlight unit.
